(19) United States
(12) Patent Application Publication
(10) Pub. No.: US 2023/0365428 A1
(43) Pub. Date: Nov. 16, 2023

(54) COMPOUND

(71) Applicant: Dyson Technology Limited, Wiltshire (GB)

(72) Inventors: Matthew Robert ROBERTS, Oxford (GB); Peter George BRUCE, Oxford (GB); Francis Gachau KINYANJUI, Nairobi (KE)

(73) Assignee: Dyson Technology Limited, Wiltshire (GB)

(21) Appl. No.: 18/199,533

(22) Filed: May 19, 2023

Related U.S. Application Data
(62) Division of application No. 16/955,022, filed on Jun. 17, 2020.

(30) Foreign Application Priority Data
Dec. 18, 2017 (GB) 1721177.2

(51) Int. Cl. C01G 53/00; H01M 4/62; H01M 4/525; H01M 4/505; H01M 4/131

(52) U.S. Cl. CPC C01G 53/50; H01M 4/623; H01M 4/525; H01M 4/505; H01M 4/625; H01M 4/131; C01P 2002/72; C01P 2002/20; C01P 2006/40

(57) ABSTRACT

A compound of the general formula:

$${Li}_{( \frac{4}{3} - \frac{2 x}{3} - \frac{y}{3} - \frac{z}{3} )} {Ni}_{x} {Co}_{y} {Al}_{z} {Mn}_{( \frac{2}{3} - \frac{K}{3} - \frac{2 y}{3} - \frac{2 z}{3} )} {O}_{2}$$

wherein x is equal to or greater than 0 and equal to or less than 0.4; y is equal to or greater than 0.1 and equal to or less than 0.4; and z is equal to or greater than 0.02 and equal to or less than 0.3. The compound is also formulated into a positive electrode for use in an electrochemical cell.

### REFERENCE TO RELATED APPLICATIONS

This application is a national stage application under 35 U.S.C. 371 of International Application No. PCT/GB2018/053656, filed Dec. 18, 2018, which claims the priority of United Kingdom Application No. 1721177.2, filed Dec. 18, 2017, the entire contents of each of which are incorporated herein by reference.

### FIELD OF THE DISCLOSURE

The present invention relates to a set of electroactive cathode compounds. More specifically the present invention relates to a set of high capacity lithium rich compounds.

### BACKGROUND OF THE DISCLOSURE

Conventional lithium ion batteries are limited in performance by the capacity of the material used to make the positive electrode (cathode). Lithium rich blends of cathode materials containing blends of nickel manganese cobalt oxide offer a trade-off between safety and energy density. It is understood that charge is stored in the transition metal cations within such cathode materials. It has been suggested that the capacity, and therefore energy density, of cathode materials could be significantly increased if charge could be stored on anions (for example oxygen) reducing the need for such high amounts of heavy transition metal ions. However, a challenge remains to provide a material that can rely on the redox chemistries of both the anions and cations to store charge, and withstand charge/discharge cycles without compromising the safety of the material, or causing undesired redox reactions which would break down the material.

### SUMMARY OF THE DISCLOSURE

In a first aspect, the present invention provides a compound of the general formula:

$${Li}_{( \frac{4}{3} - \frac{2 x}{3} - \frac{y}{3} - \frac{z}{3} )} {Ni}_{x} {Co}_{y} {Al}_{z} {Mn}_{( \frac{2}{3} - \frac{K}{3} - \frac{2 y}{3} - \frac{2 z}{3} )} {O}_{2}$$

wherein x is equal to or greater than 0 and equal to or less than 0.4; y is equal to or greater than 0.1 and equal to or less than 0.4; and z is equal to or greater than 0.02 and equal to or less than 0.3.

It has been found that a compound with an improved capacity can be achieved by reducing the amount of excess lithium and increasing the amount of nickel and/or cobalt and introducing an amount of aluminium. The particular compound as defined above exhibits a significantly large increase in capacity due to the degree of oxidation of the transition metals, the aluminium and also the oxidation of the oxide ions within the lattice. Without wishing to be bound by theory, it is understood that the presence of a particular amount of nickel and/or cobalt with an amount of aluminium substitution enables greater oxygen redox activity and thereby improves the electrochemical capacity of the material.

In addition, the compounds of the present invention exhibit improved stability during electrochemical cycling when compared to the transition metal substituted NMC lithium rich materials of the prior art. The evolution of molecular oxygen is ubiquitous with third row lithium-rich materials transition metal oxides where lithium has been exchanged for some of the transition metal ions (Li₁₊ₓM₁₋ₓO₂, where M is Ti, V, Cr, Mn, Fe, Co, Ni, Cu or Zn). These materials generally rely on oxygen redox to improve their charge capacity properties. Homogenous materials can suffer from molecular oxygen escaping from the crystal structure during cycling due to redox of the oxide anion. In turn, this reduces the capacity and useful lifetime of the material. However, the material of the present invention has improved capacity which is maintained over numerous cycles.

It is understood that when the charge imbalance caused by the removal of a lithium ion is balanced by the removal of an electron from the oxygen anion the resulting oxygen anion is unstable which results in undesired redox reactions and the evolution of molecular oxygen gas during charge cycling. Without wishing to be bound by theory, it is understood that the specific nickel, cobalt and aluminium content in the material relative to the lithium content avoids under-bonding within the lattice such that each oxygen anion is still bonded to ˜3 cations. A potential solution to this problem might be to encapsulate the cathode layer or part of the cell in a gas impermeable membrane. However, this would add parasitic mass to the cell, thereby reducing the energy density of the resulting battery. However, the chemical approach of the present invention tunes the structure of the lattice using specific amounts of transition metals reduces the generation of oxygen gas from the material without the need to add layers to the cathode material or resulting battery cell.

The substitution of aluminium ions specifically for cobalt ions is advantageous for at least two reasons. Firstly, cobalt is provided in the lattice in either the Co²⁺ or Co³⁺ oxidation state. However, aluminium is provided in the lattice only as Al³⁺ ions. Thus, aluminium is substituted for cobalt ions in the Co³⁺ oxidation state, thereby ensuring that the charge balance of ions during a charge discharge cycle is maintained at this level of redox potential. Secondly, the atomic weight of aluminium is significantly less than cobalt. Therefore the general compound is lighter in weight without compromising capacity benefits, thus increasing the energy density of the material, and any subsequent cell using the material.

In examples x may be equal to or greater than 0 and equal to or less than 0.4, x may be equal to or greater than 0.2 and equal to or less than 0.4,x may be equal to or greater than 0.1 and equal to or less than 0.3,x may be equal to or greater than 0.1 and equal to or less than 0.2. Specifically x may equal 0.2, x may be equal to or greater than 0.375 and equal to or less than 0.55.

When x is 0.375, y may have a value equal to or greater than 0.275 and equal to or less than 0.325, and z may have a value equal to or greater than 0.025 and equal to or less than 0.075; when x is 0.4, y may have a value equal to or greater than 0.225 and equal to or less than 0.275, and z may have a value equal to or greater than 0.025 and equal to or less than 0.075; when x is 0.425, y may have a value equal to or greater than 0.175 and equal to or less than 0.225, and z may have a value equal to or greater than 0.025 and equal to or less than 0.075; and when x has value equal to or greater than 0.41 to less than or equal to 0.55, y may have a value equal to or greater than 0.025 and equal to or less than 0.275, and z may have a value equal to or greater than 0.025 and equal to or less than 0.075.

Notwithstanding the above, y may be equal to or greater than 0.1 and equal to or less than 0.4, y may be equal to or greater than 0.1 and equal to or less than 0.3, y may be equal to or greater than 0.1 and equal to or less than 0.2, y may be equal to or greater than 0.1 and equal to or less than 0.15. Specifically y may equal 0.1 or 0.15. When y is 0.025, x has a value equal to or greater than 0.4 and equal to or less than 0.55, and z has a value equal to or greater than 0.025 and equal to or less than 0.075; when y is 0.05, x has a value equal to or greater than 0.5 and equal to or less than 0.525, and z has a value equal to or greater than 0.025 and equal to or less than 0.05; preferably z has a value equal to 0.05; when y is 0.075, x has a value equal to or greater than 0.475 and equal to or less than 0.525, and z has a value equal to or greater than 0.025 and equal to or less than 0.075; when y is 0.1, x has a value equal to or greater than 0.475 and equal to or less than 0.5, and z has a value equal to or greater than 0.025 and equal to or less than 0.05; preferably z has a value equal to 0.05; when y is 0.125, x has a value equal to or greater than 0.45 and equal to or less than 0.5, and z has a value equal to or greater than 0.025 and equal to or less than 0.075; when y is 0.15, x has a value equal to or greater than 0.45 and equal to or less than 0.475, and z has a value equal to 0.05; when y is 0.175, x has a value equal to or greater than 0.425 and equal to or less than 0.475, and z has a value equal to 0.025 or 0.075; when y is 0.2, x has a value equal to or greater than 0.425 and equal to or less than 0.442, and z has a value equal to 0.05; preferably x has a value equal to or greater than 0.425 and equal to or less than 0.433; when y is 0.225, x has a value equal to or greater than 0.4 and equal to or less than 0.45, and z has a value equal to 0.025 or 0.075; when y is 0.25, x has a value equal to or greater than 0.4 and equal to or less than 0.41, and z has a value equal to 0.05; when y is 0.275, x has a value equal to or greater than 0.375 and equal to or less than 0.41, and z has a value equal to 0.025 or 0.075; when y is 0.3, x has a value equal to 0.375, and z has a value equal to 0.05; when y is 0.325, x has a value equal to 0.375, and z has a value equal to 0.025.

Notwithstanding the above, in a particular embodiment, z may be greater than 0.02 and equal to or less than 0.3 z may be equal to or greater than 0.05 and equal to or less than 0.3, z may be equal to or greater than 0.1 and equal to or less than 0.3, z may be equal to or greater than 0.15 and equal to or less than 0.3, z may be equal to or greater than 0.05 and equal to or less than 0.15, z may be equal to or greater than 0.025 and equal to or less than 0.075. Specifically z may equal 0.05. When z has value equal to or greater than 0.05, y may have a value equal to or greater than 0.05 and equal to or less than 0.325, and x may have a value equal to or greater than 0.425 and equal to or less than 0.55.

In examples x is equal to 0.2; y is equal 0.15; and z is equal 0.05. This particular compound is thus Li_{1.1333}Ni_{0.2}Co_{0.15}Al_{0.05}Mn_{0.4667}O₂. In an alternative particular embodiment x is equal to 0.2; y is equal 0.1; and z is equal 0.05. This alternative particular compound is thus Li_{1.5}Ni_{0.2}Co_{0.1}Al_{0.05}Mn_{0.5}O₂. These particular compounds have demonstrated an improved capacity for charge and good stability over a number of cycles.

The compound may be defined as having a layered structure. Typically layered structures have been shown to have the highest energy density. When in the layered form, the material can be further defined using the general formula (1-a-b-c)L₂MnO₃·aLiCoO₂·bLiNi_{0.5}Mn_{0.5}O₂·cLiAlO₂ such that a=y; b=2x and c=z. Thus, a may equal to or less than 0.15; b is 0.4; and c is equal to or greater than 0.05. More specifically, a is equal or greater than 0.1 and equal to or less than 0.15; and c is equal to or greater than 0.05 and equal to or less than 0.1. Specifically the material may be 0.4L₂MnO₃·0.15LiCoO₂·0.4LiNi_{0.5}Mn_{0.5}O₂·0.05LiAlO₂, or the material may be 0.45L₂MnO₃·0.1LiCoO₂·0.4LiNi_{0.5}Mn_{0.5}O₂·0.05LiAlO₂. These particular layered structures exhibit improved capacity and a higher degree of stability during a charge/discharge cycle.

In a second aspect, the present invention provides an electrode comprising the compound of the first aspect. In a particular embodiment the electrode comprises 3 fractions. The first is the compound of the present invention as previously described (in a variety of mass percentages from 60-98%, however, typically 70, 75, 80, 90 and 95%). The second fraction of the electrode comprises electroactive additives such as carbon, for example, Super P (RTM) and Carbon black, which comprises 60-80% of the mass fraction remaining excluding the first fraction. The third fraction is typically a polymeric binder such as PVDF, PTFE, NaCMC and NaAlginate. In some case additional fractions maybe included and the overall percentages may change. The overall electrochemical performance of the cathode material can be improved by the introduction of electroactive additives, and the structural properties of the resulting cathode can also be improved by adding material that improves cohesion of the cathode material and adhesion of the material to particular substrates.

In a third aspect, the present invention provides an electrochemical cell comprising a positive electrode according to the description above, an electrolyte and a negative electrode (anode).

### BRIEF DESCRIPTION OF THE FIGURES

In order that the present invention may be more readily understood, an embodiment of the invention will now be described, by way of example, with reference to the accompanying

Figures, in which:

FIGS. 1A-1B show powder X-ray Diffraction patterns of the synthesised materials in Example 1;

FIGS. 2A-2B show first cycle galvanostatic load curves for the synthesised materials in Example 1;

FIG. 3 shows OEMS analysis of one of the materials according to the present invention; and

FIG. 4 shows ternary contour plots capacity and energy maps during discharge for materials of the present invention at 30° C., cycle 1, 2-4.8 V vs. Li/Li⁺; and

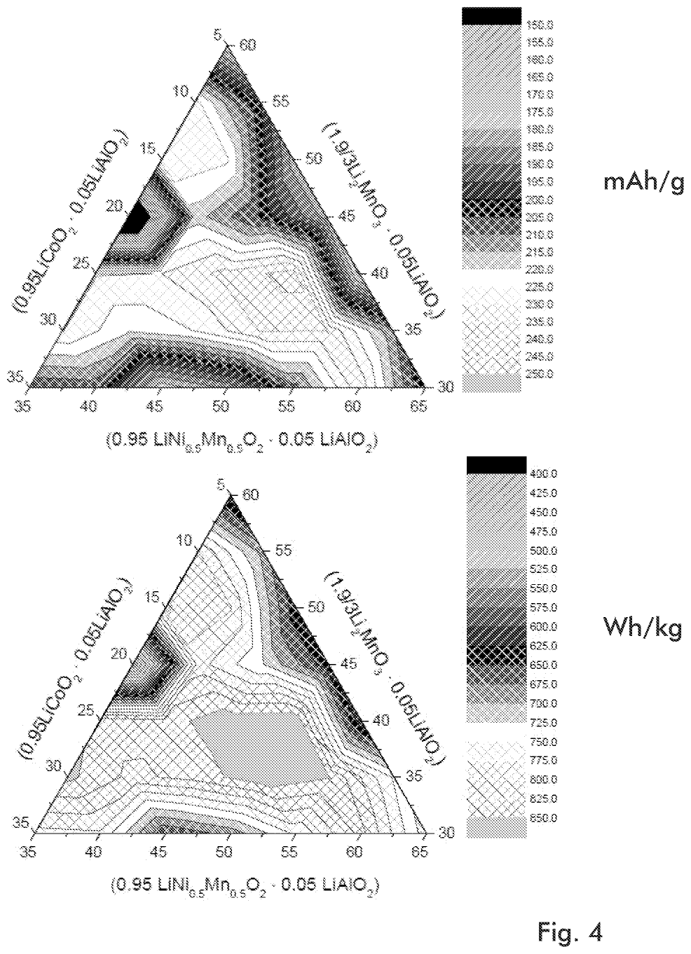

FIG. 5 shows ternary contour plots gas loss maps during discharge for materials of the present invention at 30° C., C/10, 2-4.8 V vs. Li/Li′.

### DETAILED DESCRIPTION OF THE DISCLOSURE

The present invention will now be illustrated with reference to the following examples.

### Example 1—Synthesis of the Nickel-Cobalt-Aluminium Substituted Lithium Rich Materials

The Formaldehyde-Resorcinol sol gel synthetic route was employed to synthesise materials with general formula

$${Li}_{( \frac{4}{3} - \frac{2 x}{3} - \frac{y}{3} - \frac{z}{3} )} {Ni}_{x} {Co}_{y} {Al}_{z} {Mn}_{( \frac{2}{3} - \frac{K}{3} - \frac{2 y}{3} - \frac{2 z}{3} )} {O}_{2}$$

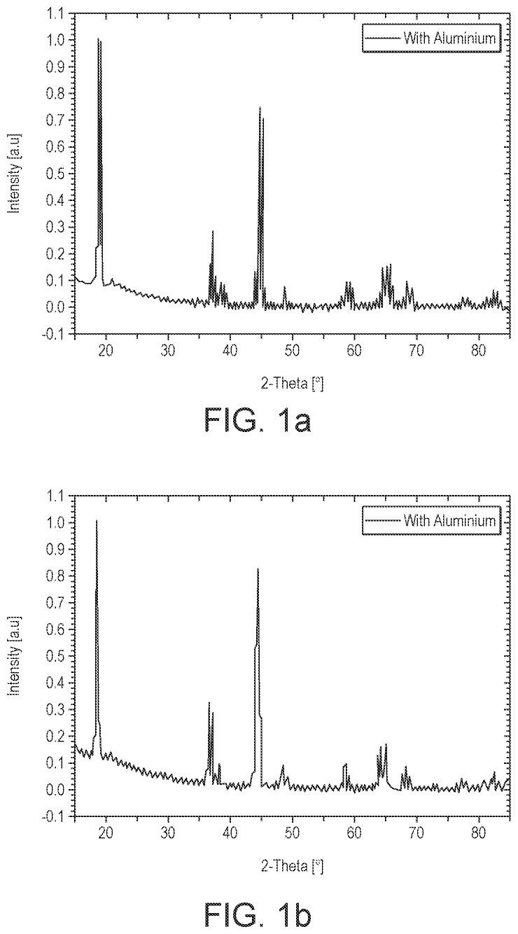

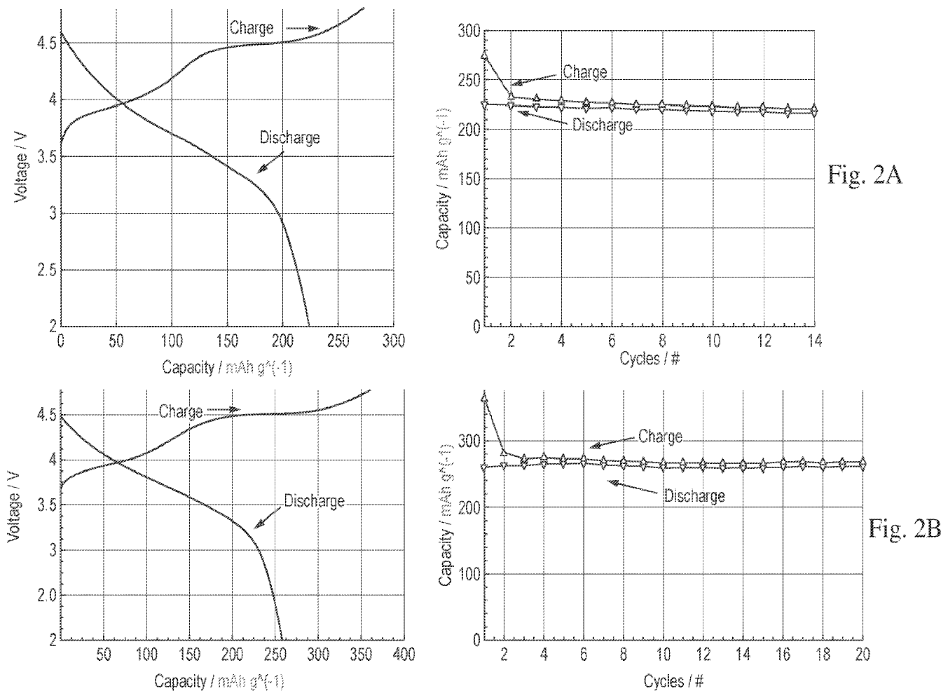

with a composition having x=0.2 y=0.15 z=0.05 (composition in FIGS. 1A and 2A); and with a composition having x=0.2 y=0.1 z=0.05 (composition in FIGS. 1B and 2B). An additional composition having x=0.25 y=0.1 z=0.05 was also synthesised.

All the reagents ratios were calculated in order to obtain 0.01 mol of the final product.

Stoichiometric amounts of CH₃COOLi·2H₂O (98.0%, Sigma Aldrich (RTM)), (CH₃COO)₂Mn·4H₂O (>99.0%, Sigma Aldrich (RTM)), (CH₃COO)₂Co·4H₂O (99.0% Sigma Aldrich (RTM)), Al₂(SO₄)₃·4H₂O (Sigma Aldrich (RTM)) and (CH₃COO)₂Ni·4H₂O (99.0% Sigma Aldrich (RTM)) were dissolved in 50 mL of water with 0.25 mmol of CH₃COOLi·2H₂O (99.0%, Sigma Aldrich (RTM)) corresponding to 5% moles of lithium with respect to the 0.01 moles of synthesized material. At the same time 0.1 mol of resorcinol (99.0%, Sigma Aldrich (RTM)) was dissolved in 0.15 mol of formaldehyde (36.5% w/w solution in water, Fluka (RTM)). Once all the reagents were completely dissolved in their respective solvents, the two solutions were mixed and the mixture was vigorously stirred for 1 hour. The resulting solution, containing 5% molar excess of lithium, was subsequently heated in an oil bath at 80° C. until the formation of a homogeneous white gel.

The gel was finally dried at 90° C. overnight and then heat treated at 500° C. for 15 hours and 800° C. for 20 hours.

### Example 2—Structural Analysis and Characterisation of the Nickel-Cobalt-Aluminium Substituted Lithium Rich Materials

The materials according to Example 1 were examined with Powder X-Ray Diffraction (PXRD) which was carried out utilising a Rigaku (RTM) SmartLab equipped with a 9 kW Cu rotating anode.

FIGS. 1A-1B show Powder X-ray Diffraction patterns of the synthesised materials. These are characteristic of a layered materials with some cation ordering in the transition layer. All of the patterns appear to show the major peaks consistent with a close-packed layered structure such as LiTMO₂ with a R-3m space group. Additional peaks are observed in the range 20-30 2Theta degrees which cannot be assigned to the R-3m space. The order derives from the atomic radii and charge density differences between Li⁺ (0.59 Å), Ni⁺² (0.69 Å) and Mn⁴⁺ (0.83 Å) and appears the strongest in the structures of the low nickel doped oxides. The peaks are not as strong as in materials where a perfect order exists as in Li₂MnO₃. No presence of extra-peaks due to impurities was observed.

### Example 3—Electrochemical Analysis of the Nickel-Cobalt-Aluminium Substituted Lithium Rich Materials

The materials according to Example 1 were characterised electrochemically through galvanostatic cycling performed with a BioLogic VMP3 and a Maccor 4600 series potentiostats. All the samples were assembled into stainless steel coincells against metallic lithium and cycled between 2 and 4.8 V vs. Li⁺/Li for 100 cycles at a current rate of 50 mAg⁻¹. The electrolyte employed was LP30 (a 1M solution of LiPF₆ in 1:1 w/w ratio of EC:DMC). FIGS. 2A-2B show the potential curves during the charge and subsequent discharge of the first cycle for each material according to Example 1. Both samples present a high voltage plateau of different lengths centered on 4.5 V vs. Li⁺/Li⁰, and a sloped region at the beginning of the charge. The length of this region may be attributed to the oxidation of nickel from Ni⁺² toward Ni⁺⁴ and Co⁺³ toward Co⁺⁴ and appears to be in good agreement with the amount of lithium (i.e. charge) that would be extracted accounting for solely the transition metal redox activity.

During the first discharge, neither material shows the presence of a reversible plateau, indicating a difference in the thermodynamic pathways followed during the extraction (charge) and insertion (discharge) of lithium ions from/in the lattice of each sample.

For both materials according to Example 1 the first cycle presents the lowest coulombic efficiency value due to the presence of the high potential plateau which is not reversible. The coulombic efficiencies appear to quickly improve from the first cycle values, around 60-80%, to values higher than 98% within the first five cycles.

Compositions demonstrating the technical benefits in accordance with the Examples and the present invention are detailed below.

| Composition | Li | Mn | Co | Ni | Al | O |
|---|---|---|---|---|---|---|
| 1 | 1.15 | 0.25 | 0.025 | 0.55 | 0.025 | 2 |
| 2 | 1.15 | 0.225 | 0.075 | 0.525 | 0.025 | 2 |
| 3 | 1.15 | 0.2 | 0.125 | 0.5 | 0.025 | 2 |
| 4 | 1.15 | 0.175 | 0.175 | 0.475 | 0.025 | 2 |
| 5 | 1.133333 | 0.275 | 0.025 | 0.541667 | 0.025 | 2 |
| 6 | 1.133333 | 0.25 | 0.075 | 0.516667 | 0.025 | 2 |
| 7 | 1.133333 | 0.225 | 0.125 | 0.491667 | 0.025 | 2 |
| 8 | 1.133333 | 0.2 | 0.175 | 0.466667 | 0.025 | 2 |
| 9 | 1.133333 | 0.175 | 0.225 | 0.441667 | 0.025 | 2 |
| 10 | 1.116667 | 0.3 | 0.025 | 0.533333 | 0.025 | 2 |
| 11 | 1.116667 | 0.275 | 0.075 | 0.508333 | 0.025 | 2 |
| 12 | 1.116667 | 0.25 | 0.125 | 0.483333 | 0.025 | 2 |
| 13 | 1.116667 | 0.225 | 0.175 | 0.458333 | 0.025 | 2 |
| 14 | 1.116667 | 0.2 | 0.225 | 0.433333 | 0.025 | 2 |
| 15 | 1.116667 | 0.175 | 0.275 | 0.408333 | 0.025 | 2 |
| 16 | 1.1 | 0.325 | 0.025 | 0.525 | 0.025 | 2 |
| 17 | 1.1 | 0.3 | 0.075 | 0.5 | 0.025 | 2 |
| 18 | 1.1 | 0.275 | 0.125 | 0.475 | 0.025 | 2 |
| 19 | 1.1 | 0.25 | 0.175 | 0.45 | 0.025 | 2 |
| 20 | 1.1 | 0.225 | 0.225 | 0.425 | 0.025 | 2 |
| 21 | 1.1 | 0.2 | 0.275 | 0.4 | 0.025 | 2 |
| 22 | 1.1 | 0.175 | 0.325 | 0.375 | 0.025 | 2 |
| 23 | 1.15 | 0.25 | 0 | 0.55 | 0.05 | 2 |
| 24 | 1.15 | 0.225 | 0.05 | 0.525 | 0.05 | 2 |
| 25 | 1.15 | 0.2 | 0.1 | 0.5 | 0.05 | 2 |
| 26 | 1.15 | 0.175 | 0.15 | 0.475 | 0.05 | 2 |
| 27 | 1.133333 | 0.275 | 0 | 0.541667 | 0.05 | 2 |
| 28 | 1.133333 | 0.25 | 0.05 | 0.516667 | 0.05 | 2 |
| 29 | 1.133333 | 0.225 | 0.1 | 0.491667 | 0.05 | 2 |
| 30 | 1.133333 | 0.2 | 0.15 | 0.466667 | 0.05 | 2 |
| 31 | 1.133333 | 0.175 | 0.2 | 0.441667 | 0.05 | 2 |
| 32 | 1.116667 | 0.3 | 0 | 0.533333 | 0.05 | 2 |
| 33 | 1.116667 | 0.275 | 0.05 | 0.508333 | 0.05 | 2 |
| 34 | 1.116667 | 0.25 | 0.1 | 0.483333 | 0.05 | 2 |
| 35 | 1.116667 | 0.225 | 0.15 | 0.458333 | 0.05 | 2 |
| 36 | 1.116667 | 0.2 | 0.2 | 0.433333 | 0.05 | 2 |
| 37 | 1.116667 | 0.175 | 0.25 | 0.408333 | 0.05 | 2 |
| 38 | 1.1 | 0.325 | 0 | 0.525 | 0.05 | 2 |
| 39 | 1.1 | 0.3 | 0.05 | 0.5 | 0.05 | 2 |
| 40 | 1.1 | 0.275 | 0.1 | 0.475 | 0.05 | 2 |
| 41 | 1.1 | 0.25 | 0.15 | 0.45 | 0.05 | 2 |
| 42 | 1.1 | 0.225 | 0.2 | 0.425 | 0.05 | 2 |
| 43 | 1.1 | 0.2 | 0.25 | 0.4 | 0.05 | 2 |
| 44 | 1.1 | 0.175 | 0.3 | 0.375 | 0.05 | 2 |
| 45 | 1.15 | 0.225 | 0.025 | 0.525 | 0.075 | 2 |
| 46 | 1.15 | 0.2 | 0.075 | 0.5 | 0.075 | 2 |
| 47 | 1.15 | 0.175 | 0.125 | 0.475 | 0.075 | 2 |
| 48 | 1.133333 | 0.25 | 0.025 | 0.516667 | 0.075 | 2 |
| 49 | 1.133333 | 0.225 | 0.075 | 0.491667 | 0.075 | 2 |
| 50 | 1.133333 | 0.2 | 0.125 | 0.466667 | 0.075 | 2 |
| 51 | 1.133333 | 0.175 | 0.175 | 0.441667 | 0.075 | 2 |
| 52 | 1.116667 | 0.275 | 0.025 | 0.508333 | 0.075 | 2 |
| 53 | 1.116667 | 0.25 | 0.075 | 0.483333 | 0.075 | 2 |
| 54 | 1.116667 | 0.225 | 0.125 | 0.458333 | 0.075 | 2 |
| 55 | 1.116667 | 0.2 | 0.175 | 0.433333 | 0.075 | 2 |
| 56 | 1.116667 | 0.175 | 0.225 | 0.408333 | 0.075 | 2 |
| 57 | 1.1 | 0.3 | 0.025 | 0.5 | 0.075 | 2 |
| 58 | 1.1 | 0.275 | 0.075 | 0.475 | 0.075 | 2 |
| 59 | 1.1 | 0.25 | 0.125 | 0.45 | 0.075 | 2 |
| 60 | 1.1 | 0.225 | 0.175 | 0.425 | 0.075 | 2 |
| 61 | 1.1 | 0.2 | 0.225 | 0.4 | 0.075 | 2 |
| 62 | 1.1 | 0.175 | 0.275 | 0.375 | 0.075 | 2 |

Compositions demonstrating higher levels of the technical benefits in accordance with the Examples and the present invention are detailed below.

| Composition | Li | Mn | Co | Ni | Al | O |
|---|---|---|---|---|---|---|
| 1 | 1.15 | 0.25 | 0 | 0.55 | 0.05 | 2 |
| 2 | 1.15 | 0.225 | 0.05 | 0.525 | 0.05 | 2 |
| 3 | 1.15 | 0.2 | 0.1 | 0.5 | 0.05 | 2 |
| 4 | 1.15 | 0.175 | 0.15 | 0.475 | 0.05 | 2 |
| 5 | 1.133333 | 0.275 | 0 | 0.541667 | 0.05 | 2 |
| 6 | 1.133333 | 0.25 | 0.05 | 0.516667 | 0.05 | 2 |
| 7 | 1.133333 | 0.225 | 0.1 | 0.491667 | 0.05 | 2 |
| 8 | 1.133333 | 0.2 | 0.15 | 0.466667 | 0.05 | 2 |
| 9 | 1.116667 | 0.3 | 0 | 0.533333 | 0.05 | 2 |
| 10 | 1.116667 | 0.275 | 0.05 | 0.508333 | 0.05 | 2 |
| 11 | 1.116667 | 0.25 | 0.1 | 0.483333 | 0.05 | 2 |
| 12 | 1.116667 | 0.225 | 0.15 | 0.458333 | 0.05 | 2 |
| 13 | 1.116667 | 0.2 | 0.2 | 0.433333 | 0.05 | 2 |
| 14 | 1.1 | 0.325 | 0 | 0.525 | 0.05 | 2 |
| 15 | 1.1 | 0.3 | 0.05 | 0.5 | 0.05 | 2 |
| 16 | 1.1 | 0.275 | 0.1 | 0.475 | 0.05 | 2 |
| 17 | 1.1 | 0.25 | 0.15 | 0.45 | 0.05 | 2 |
| 18 | 1.1 | 0.225 | 0.2 | 0.425 | 0.05 | 2 |

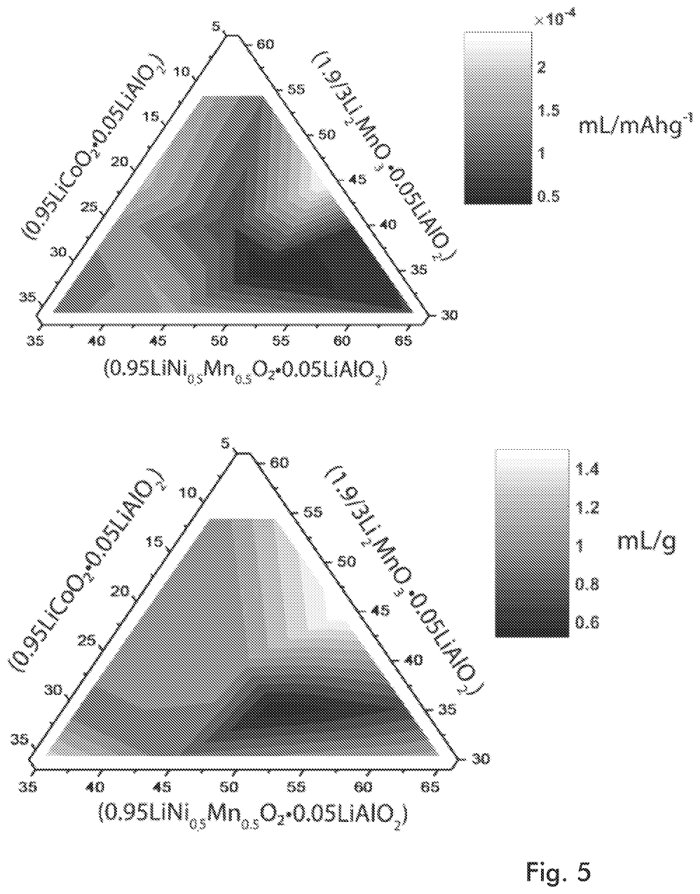

These materials were tested in accordance with the method above, and the results are shown in FIG. 5 as a ternary contour plot capacity and energy map during discharge for materials of the present invention at 30° C. and 55° C. C/10, 2-4.8 V vs. Li/Li⁺.

### Example 4— Gas Evolution During the First Cycle of the Nickel-Cobalt-Aluminium Substituted Lithium Rich Materials

One pellet of Composition 1 Li_{1.1333}Co_{0.15}Al_{0.05}Ni_{0.2}Mn_{0.4667}O₂ was assembled into a Swagelok (RTM) test cell specifically machined to carry out an Operando Electrochemical Mass Spectrometry (OEMS) measurement. The mass spectrometry measurement involved in the OEMS experiment was performed with a Thermo-Fisher quadrupolar mass spectrometer. OEMS was performed on the set of materials in order to get an insight on the origin of the extra-capacity that is observed during the first cycle.

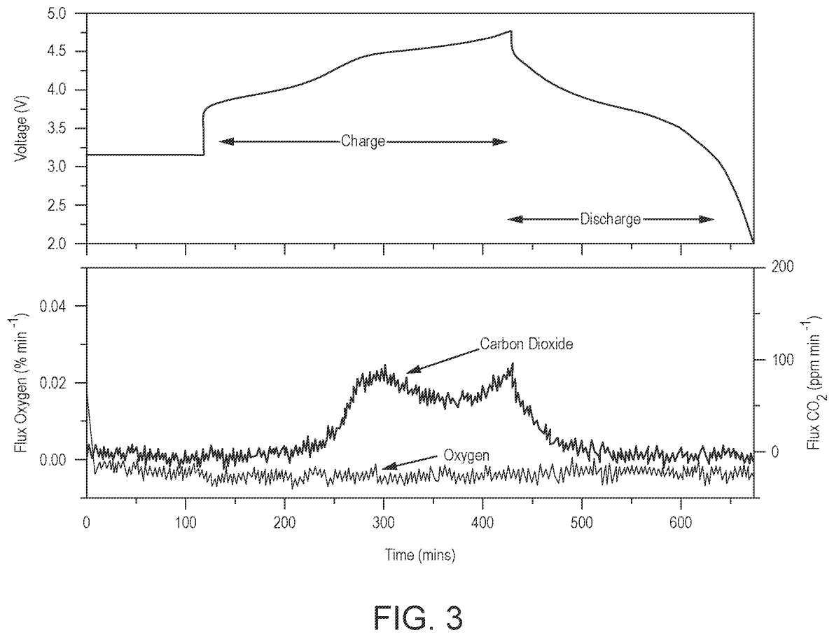

FIG. 3 shows OEMS analysis of the nickel doped Li_{1.1333}Co_{0.15}Al_{0.05}Ni_{0.2}Mn_{0.4667}O₂ respectively. The graph shows the galvanostatic curve during the first two cycles (top lines in each graph), the oxygen trace, and the carbon dioxide trace for each material. Argon was used as carrier gas with a flux rate of 0.7 mL/min and the electrode was cycled against metallic lithium at a rate of 15 mAg⁻¹ between 2 and 4.8 V vs. Li⁺/Li⁰ for all the materials. The electrolyte employed was a 1M solution of LiPF₆ in propylene carbonate.

CO₂ was the only gaseous species detected for all the samples], with a progressively lower amount of gas released as the amount of dopant nickel increases. CO₂ peaks at the beginning of the high potential plateau (around 4.5 V vs. Li⁺/Li⁰ region and progressively decreasing until the end of charge.

One pellet of each material according to the present invention (as tabulated above in Example 3) was assembled into a EL-Cell PAT-Cell-Press (RTM) single cell. All the samples were assembled versus metallic lithium and cycled from OCV to 4.8 V vs. Li⁺/Li and then discharged to 2V at a current rate of 50 mAg⁻¹. The electrolyte employed was LP30 (a 1M solution of LiPF₆ in 1:1 w/w ratio of EC:DMC). This cell was specifically designed to record the pressure changes within the headspace, this could then be related to the mols of gas evolved from the cathode. The pressure sensor in the cell was connected via a controller box which was linked to a computer via a USB link. This was then logged via the Datalogger and EC-Link Software provided by EL-Cell (RTM). The data was logged as Voltage, Current, time and pressure. These values could be combined through the ideal gas law to calculate the number of mols of gas evolved on cycling which could be used to calculate the volume of gas evolved under ambient conditions. The total gas loss for each material during charge was calculated and a contour plot generated as FIG. 5 which shows gas loss as a function of composition within the ternary space.

1. A compound of the general formula:
$${Li}_{( \frac{4}{3} - \frac{2 x}{3} - \frac{y}{3} - \frac{z}{3} )} {Ni}_{x} {Co}_{y} {Al}_{z} {Mn}_{( \frac{2}{3} - \frac{K}{3} - \frac{2 y}{3} - \frac{2 z}{3} )} {O}_{2}$$
wherein x is equal to or greater than 0.2 and equal to or less than 0.3;
wherein y is equal to or greater than 0.025 and equal to or less than 0.325;
wherein z is equal to or greater than 0.025 and equal to or less than 0.075; and
wherein
$$x + y + z + ( \frac{2}{3} - \frac{x}{3} - \frac{2 y}{3} - \frac{2 z}{3} )$$
is equal to or less than 0.9.

2. The compound according to claim 1, wherein x+y+z is greater than 0.4 and equal to or less than 0.7.

3. The compound according to claim 1, wherein x+y+z is equal to or greater than 0.35 and equal to or less than 0.7.

4. The compound according to claim 1, wherein z is equal to 0.05, and x+y=0.3.

5. The compound according to claim 1, wherein z is equal to 0.05, and x+y=0.35.

6. The compound according to claim 1, wherein x is equal to 0.2; y is equal 0.15; and z is equal 0.05.

7. The compound according to claim 1, wherein x is equal to 0.2; y is equal 0.1; and z is equal 0.05.

8-28. (canceled)

29. The compound according to claim 1, wherein the compound is a cathode material having a layered structure.

30. The compound according to claim 29, wherein the layered structure is expressed as the general formula:
(1-a-b-c)Li₂MnO₃·aLiCoO₂·bLiNi_{0.5}Mn_{0.5}O₂·cLiAlO₂
wherein a is equal to y;
b is equal to 2x;
and c is equal to z.

31. (canceled)

32. The compound according to claim 30, wherein the material is 0.4Li₂MnO₃·0.15LiCoO₂·0.4LiNi_{0.5}Mn_{0.5}O₂·0.05LiAlO₂.

33. The compound according to claim 30, wherein the material is 0.45Li₂MnO₃·0.1LiCoO₂·0.4LiNi_{0.5}Mn_{0.5}O₂·0.05LiAlO₂.

34. (canceled)

35. An electrode comprising the compound according to claim 1.

36. The electrode according to claim 35, wherein the electrode comprises at least one of electroactive additives and a polymeric binder.

37. The electrode according to claim 36, wherein the electroactive additive is selected from at least one of carbon or carbon black.

38. The electrode of claim 36, wherein the polymeric binder is selected from at least one of PVDF, PTFE, NaCMC or NaAlginate.

39. An electrochemical cell comprising the positive electrode according to claim 35, an electrolyte, and a negative electrode.
